(19) United States
(12) Patent Application Publication
(10) Pub. No.: US 2025/0323372 A1
(43) Pub. Date: Oct. 16, 2025

(54) BATTERY PACK

(71) Applicants: Hyundai Motor Company, Seoul (KR); Kia Corporation, Seoul (KR)

(72) Inventors: Gyung Hoon Shin, Hwaseong-Si (KR); Hae Woong Jung, Hwaseong-Si (KR)

(73) Assignees: Hyundai Motor Company, Seoul (KR); Kia Corporation, Seoul (KR)

(21) Appl. No.: 19/089,369

(22) Filed: Mar. 25, 2025

(30) Foreign Application Priority Data
Apr. 16, 2024 (KR) 10-2024-0050902
Nov. 4, 2024 (KR) 10-2024-0154680

(51) Int. Cl. H01M 50/262; H01M 10/613; H01M 10/6554; H01M 10/6556; H01M 50/211; H01M 50/258

(52) U.S. Cl. CPC H01M 50/262; H01M 10/613; H01M 10/6554; H01M 10/6556; H01M 50/211; H01M 50/258

(57) ABSTRACT

A battery pack includes two or more battery modules stacked in a vertical direction in which each battery module includes a plurality of battery stacks disposed in a horizontal direction, cooling plates provided between the two or more battery modules, and a first connection portion connecting the two battery modules provided adjacent to each other in the vertical direction, in which the first connection portion includes a first mediation member provided between the two battery modules provided adjacent to each other in the vertical direction, and an insertion member penetrating the first mediation member and one side of each of the two battery modules provided adjacent to each other in the vertical direction, and in which the insertion member is spaced apart from the cooling plate.

### CROSS-REFERENCE TO RELATED APPLICATION

The present application claims priority to Korean Patent Application No. 10-2024-0050902 filed on Apr. 16, 2024, and Korean Patent Application No. 10-2024-0154680 filed on Nov. 4, 2024, the entire contents of which is incorporated herein for all purposes by this reference.

### BACKGROUND OF THE PRESENT DISCLOSURE

### Field of the Present Disclosure

The present disclosure relates to a battery pack, and more particularly, to a battery pack including a structure in which a plurality of battery modules are stacked.

### Description of Related art

A battery pack mounted in an electric vehicle needs to have a means capable of effectively cooling a battery. Methods of cooling the batteries may be classified into an air-cooled method and a water-cooled method depending on the types of fluids used to cool the batteries in the battery packs. Among the methods, the water-cooled method may show an excellent cooling effect and thus be applied to a battery pack mounted in a high-performance electric vehicle.

Meanwhile, to meet an improvement in performance required for the battery pack, studies are being conducted on a method of stacking battery modules in the battery pack. The battery pack having a ‘multi-stage structure’ may have a structure in which a plurality of battery modules are stacked in a vertical direction, and cooling plates are fitted between the battery modules.

However, generally, because the battery pack having the multi-stage structure has the structure in which the battery modules and the cooling plates are stacked, tolerances accumulate therebetween, which makes it difficult to assemble the components in the battery pack.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to easily assembling components in a battery pack by solving a problem in which tolerances accumulate in the battery pack including a multi-stage structure.

To achieve the above-mentioned object, one aspect of the present disclosure provides a battery pack including: two or more battery modules stacked in a vertical direction and each including a plurality of battery stacks disposed in a horizontal direction thereof; cooling plates provided between the two or more battery modules; and a first connection portion connecting the two battery modules disposed adjacent to each other in the vertical direction, in which the first connection portion includes: a first mediation member provided between the two battery modules disposed adjacent to each other in the vertical direction; and an insertion member penetrating the first mediation member and one side of each of the two battery modules disposed adjacent to each other in the vertical direction, and in which the insertion member is spaced apart from the cooling plate.

The first mediation member and the cooling plate may be provided to be spaced apart from each other.

The first mediation member and the cooling plate may be provided to overlap each other in the vertical direction.

The battery module may further include an end cap member facing one side of the battery stack and fixing the battery stack, the end cap member may include: an end cap body defining a region facing the battery stack; and an end cap connection region protruding to the outside from the end cap body and facing the first mediation member in the vertical direction, and the insertion member may be provided to penetrate the first mediation member and the end cap connection region.

The battery module may include a plurality of sub-modules each including the plurality of battery stacks and the end cap member, the plurality of sub-modules may be spaced apart from one another in the horizontal direction, and the end cap member in the sub-module may be provided to face the end cap member in another sub-module provided adjacent to the end cap member in the sub-module in the horizontal direction.

The end cap connection regions of the end cap members in the two sub-modules disposed adjacent to each other in the horizontal direction may protrude in a direction toward each other.

The two or more battery modules may include: an upper battery module; and a lower battery module disposed below the upper battery module and facing the upper battery module, and at least some of the plurality of sub-modules in the upper battery module may be provided to overlap at least some of the plurality of sub-modules in the lower battery module in the horizontal direction.

The first connection portion may further include a horizontal connection member connecting the end cap members in the two sub-modules disposed adjacent to each other in the horizontal direction, the insertion member, which penetrates the end cap member provided in one of the two sub-modules disposed adjacent to each other in the horizontal direction, may penetrate a first side of the horizontal connection member, and the insertion member, which penetrates the end cap member provided in another of the two sub-modules disposed adjacent to each other in the horizontal direction, may penetrate a second side of the horizontal connection member.

The horizontal connection member may be provided to connect the two sub-modules disposed adjacent to each other in the horizontal direction in the battery module provided at an uppermost end portion among the two or more battery modules.

The insertion member may be provided to penetrate the end cap connection region of the end cap member, which is provided in the sub-module in the upper battery module, and the end cap connection region of the end cap member provided in the sub-module in the lower battery module.

A first recessed section including a recessed shape opened upward may be formed in the end cap connection region of the end cap member provided in the sub-module in the lower battery module so that the insertion member is seated in the first recessed section, and a lower end portion of the insertion member may be provided to be spaced apart from a lower surface of the first recessed section.

The battery pack may further include: a base plate defining a lower surface of the battery pack, in which the cooling plates further include a lowermost end cooling plate additionally provided between the base plate and the battery module provided at a lowermost end portion among the two or more battery modules, and in which the first connection portion may further include a bottom insertion member penetrating the base plate and one side of the battery module provided at the lowermost end portion.

The bottom insertion member may be provided to be spaced apart from the lowermost end cooling plate.

A second recessed section including a recessed shape opened upward may be formed in the base plate so that the bottom insertion member is seated in the second recessed section, and a lower end portion of the bottom insertion member may be provided to be spaced apart from a lower surface of the second recessed section.

The cooling plates may further include an uppermost end cooling plate provided above the battery module provided at an uppermost end portion among the two or more battery modules, the battery pack may further include a second connection portion coupled to one side of the uppermost end cooling plate, and the second connection portion may further include: an upper reinforcement member provided above the uppermost end cooling plate; a pad member provided between the upper reinforcement member and the uppermost end cooling plate; and a stud member penetrating the upper reinforcement member and the uppermost end cooling plate.

The stud member may be provided to be spaced apart from the pad member.

The second connection portion may further include: a second mediation member disposed between the upper reinforcement member and the end cap connection region of the end cap member provided in the sub-module of the battery module provided at the uppermost end portion among the two or more battery modules; and a coupling member coupled to the second mediation member and facing the second mediation member with the upper reinforcement member interposed therebetween.

The battery pack may further include: a reinforcement connection member connecting the battery module and the cooling plate disposed adjacent to each other in the vertical direction, in which the reinforcement connection member includes: a first surface region including one side facing one side of the battery module; and a second surface region including one side facing one side of the cooling plate.

The first surface region may be provided to face one side of the battery module in the vertical direction, and the second surface region may be provided to face one side of the cooling plate in the horizontal direction.

The battery pack may further include: a first coupling member penetrating the first surface region and one side of the battery module; and a second coupling member penetrating the second surface region and one side of the cooling plate.

A first hole may be formed in a region of the first surface region penetrated by the first coupling member, the first hole may include a shape of a circle, a second hole may be formed in a region of the second surface region penetrated by the second coupling member, and the second hole may include a shape in which a width in the vertical direction and a width in the horizontal direction are different from each other.

The width of the second hole in the vertical direction may be greater than the width of the second hole in the horizontal direction.

The reinforcement connection member may further include a third surface region including one side facing the other side of the cooling plate, and the third surface region may be provided to face the other side of the cooling plate in the horizontal direction.

The third surface region may be orthogonal to the second surface region.

The battery pack may further include: a third coupling member penetrating the third surface region and the other side of the cooling plate, in which a third hole is formed in a region of the third surface region penetrated by the third coupling member, and the third hole includes a shape in which a width in the vertical direction and a width in the horizontal direction are different from each other.

The width of the third hole in the vertical direction may be greater than the width of the third hole in the horizontal direction.

According to an exemplary embodiment of the present disclosure, it is possible to easily assemble the components in the battery pack by solving the problem in which tolerances accumulate in the battery pack including the multi-stage structure.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a battery pack according to an exemplary embodiment of the present disclosure.

FIG. 2 is an exploded perspective view exemplarily illustrating a stacked structure of the battery pack according to an exemplary embodiment of the present disclosure.

FIG. 3 is an enlarged view exemplarily illustrating a lateral structure of the battery pack according to an exemplary embodiment of the present disclosure.

FIG. 4 is an enlarged view exemplarily illustrating a state in which some surrounding components of an end cap member in FIG. 3 are removed.

FIG. 5 is a cross-sectional view exemplarily illustrating a coupling structure between two battery modules provided adjacent to each other in a vertical direction in the battery pack according to an exemplary embodiment of the present disclosure.

FIG. 6 is a cross-sectional view exemplarily illustrating a coupling structure between a horizontal connection member and the battery module provided at an uppermost end portion in the battery pack according to an exemplary embodiment of the present disclosure.

FIG. 7 is a cross-sectional view exemplarily illustrating a coupling structure between a base plate and the battery module provided at a lowermost end portion in the battery pack according to an exemplary embodiment of the present disclosure.

FIG. 8 is a top plan view of the battery pack according to an exemplary embodiment of the present disclosure.

FIG. 9 is an enlarged view exemplarily illustrating a state in which an upper reinforcement member is coupled to an upper portion of the battery module provided at the uppermost end portion in FIG. 8.

FIG. 10 is a cross-sectional view exemplarily illustrating a coupling structure between a second connection portion and the battery module provided at the uppermost end portion in FIG. 8.

FIG. 11 is a perspective view for explaining a connection structure between the battery module and a cooling plate in the battery pack according to an exemplary embodiment of the present disclosure.

FIG. 12 is an enlarged perspective view exemplarily illustrating one of reinforcement connection members in FIG. 11.

FIG. 13 is an enlarged perspective view exemplarily illustrating another of the reinforcement connection members in FIG. 11.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a battery pack according to an exemplary embodiment of the present disclosure will be described with reference to the drawings.

### Battery Pack

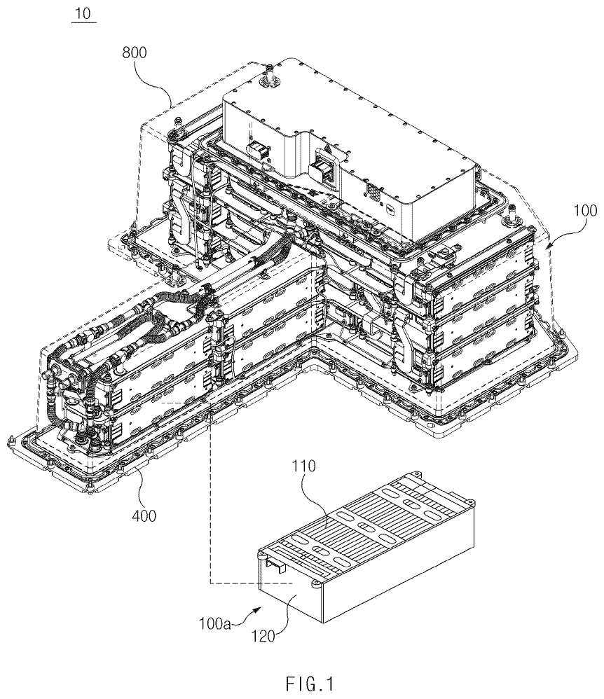

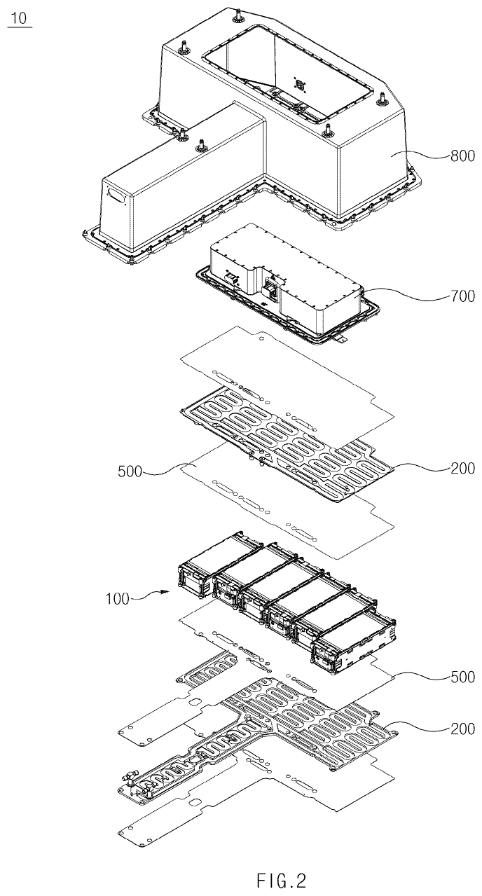

FIG. 1 is a perspective view of a battery pack according to an exemplary embodiment of the present disclosure, and FIG. 2 is an exploded perspective view exemplarily illustrating a stacked structure of the battery pack according to an exemplary embodiment of the present disclosure.

With reference to FIG. 1 and FIG. 2, a battery pack 10 according to an exemplary embodiment of the present disclosure may include battery modules 100 each including a plurality of battery stacks 110 disposed in a horizontal direction. The battery stack 110 may include a structure in which a plurality of batteries are stacked. For example, the above-mentioned battery may be a pouch-type battery. Alternatively, the battery may be a cylindrical battery or an angular battery.

Meanwhile, the battery pack 10 according to an exemplary embodiment of the present disclosure may include a configuration for cooling the battery modules 100 by absorbing heat, which is generated from the battery modules 100, and discharging the heat to the outside thereof. The battery pack 10 according to an exemplary embodiment of the present disclosure may further include cooling plates 200 provided at one side of the battery modules 100 and configured to cool the battery modules 100. A flow path may be formed in the cooling plate 200, and a cooling fluid may flow along the flow path. The fluid may absorb thermal energy of the battery module 100 while flowing along the flow path of the cooling plate 200, and the fluid may be discharged to the outside from the cooling plate 200 so that the battery module 100 may be cooled. As illustrated in FIG. 1 and FIG. 2, the cooling plates 200 may be provided above and/or below the battery modules 100 and configured to receive thermal energy from the battery modules 100 by thermal conduction.

Meanwhile, the battery pack 10 according to an exemplary embodiment of the present disclosure may further include a base plate 400 provided below the battery module 100. The battery pack 10 according to an exemplary embodiment of the present disclosure may include two or more battery modules 100 each including the plurality of battery stacks 110 disposed in the horizontal direction, and the battery modules 100 may be stacked in the vertical direction.

The cooling plates 200 may be provided between the two or more battery modules. In the instant case, the base plate 400 may be provided below the battery module 100 provided at a lowermost end portion among the plurality of battery modules 100. The base plate 400 is configured to support loads of the components of the battery pack 10 that include the battery module 100 and the cooling plate 200.

Furthermore, the battery pack 10 according to an exemplary embodiment of the present disclosure may further include electrical insulation tapes 500 provided between the battery modules 100 and the cooling plates 200. For example, the insulation tapes 500 may be attached to the battery modules 100 and the cooling plates 200. The insulation tape 500 may be configured to ensure electrical insulation between the battery module 100 and the cooling plate 200. However, because the thermal conduction between the battery module 100 and the cooling plate 200 needs to be ensured even in the instant case, the insulation tape 500 may be made of a material including electrical insulation while having excellent thermal conduction.

With continued reference to the drawings, the battery pack 10 according to an exemplary embodiment of the present disclosure may further include a power distribution unit (PDU) assembly 700 electrically connected to the plurality of battery modules 100. The PDU assembly 700 is configured to distribute electric power to a plurality of components in the battery module 100. Furthermore, the PDU assembly 700 may further include a relay member configured to perform control to turn on or off electric power, a fuse member configured to cut off electric power in an emergency situation, and a battery management system (BMS) configured to diagnose a state of the battery module 100 or a state of the battery stack 110 in the battery module 100. For example, as illustrated in the drawings, the PDU assembly 700 may be provided to face an upper surface of the cooling plate 200 provided above the battery module 100 disposed at an uppermost end portion among the plurality of battery modules 100.

Furthermore, the battery pack 10 according to an exemplary embodiment of the present disclosure may further include an upper cover member 800 configured to define a space for accommodating the battery modules 100, the cooling plates 200, the insulation tapes 500, and the like therein. The upper cover member 800, together with the base plate 400, may define an internal space of the battery pack 10 and are configured to accommodate main components of the battery pack 10 and seal the internal space from the outside thereof. A lower surface of the upper cover member 800 may be tightly attached and fixed to an upper surface of the base plate 400. Furthermore, a portion of an upper surface of the upper cover member 800 may include an opened region, and the PDU assembly 700 may be seated in the opened region.

Meanwhile, in the present specification, the vertical direction and the horizontal direction are defined based on the battery pack illustrated in the drawings. However, the vertical direction and the horizontal direction may be respectively substituted with and used as a first direction and a second direction. In the instant case, it should be understood that the first direction and the second direction are perpendicular to each other.

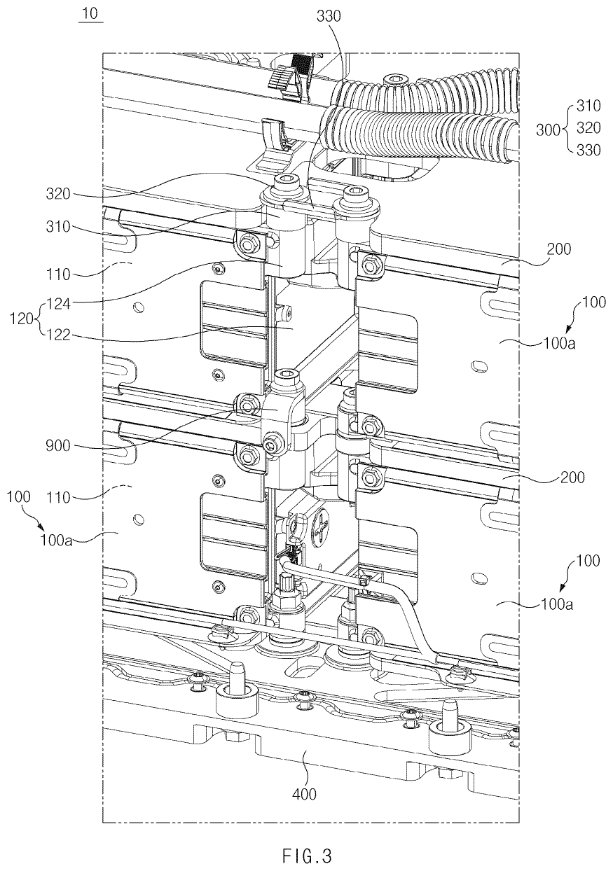

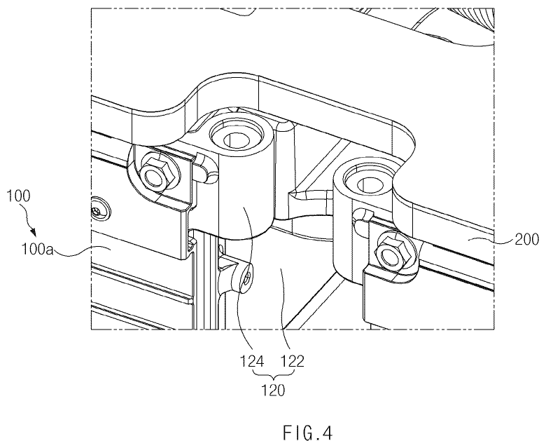

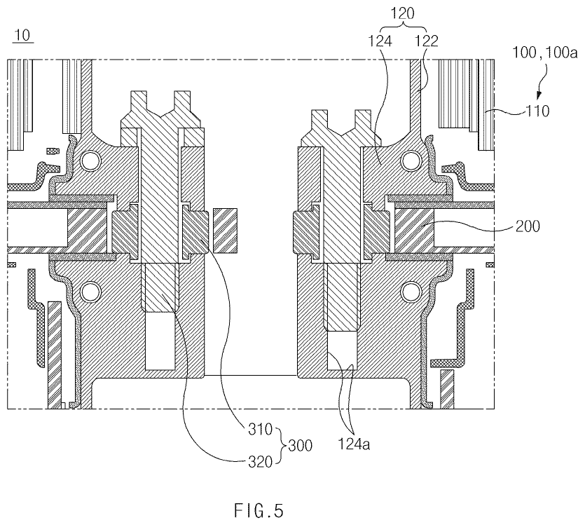

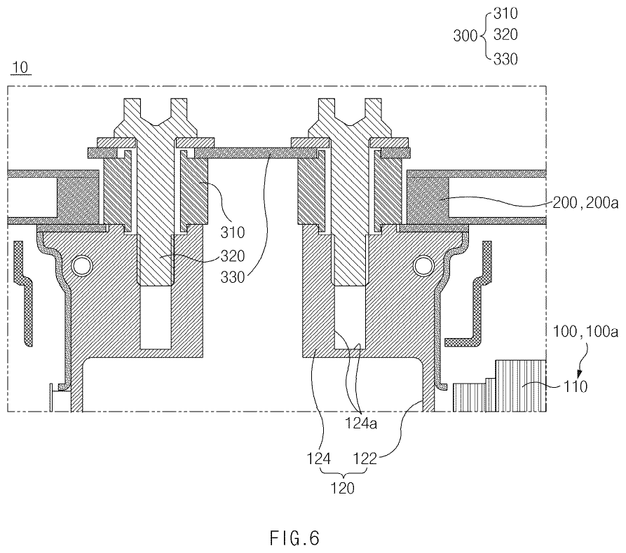

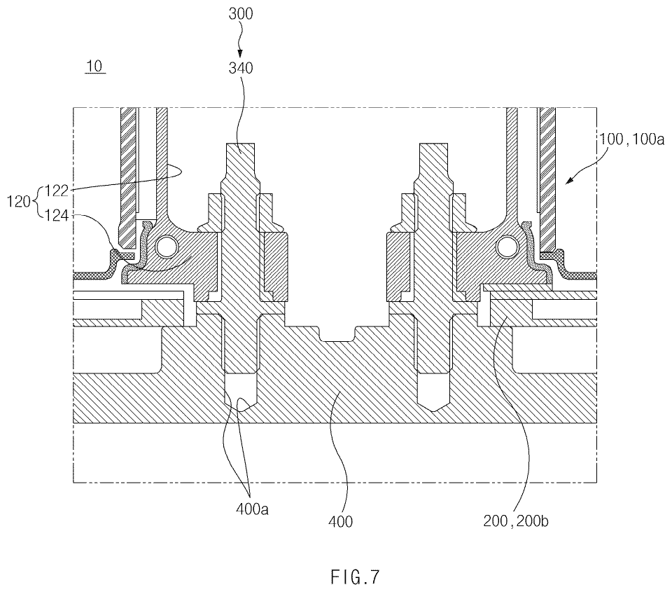

FIG. 3 is an enlarged view exemplarily illustrating a lateral structure of the battery pack according to an exemplary embodiment of the present disclosure, and FIG. 4 is an enlarged view exemplarily illustrating a state in which some surrounding components of an end cap member in FIG. 3 are removed. FIG. 5 is a cross-sectional view exemplarily illustrating a coupling structure between the two battery modules provided adjacent to each other in the vertical direction in the battery pack according to an exemplary embodiment of the present disclosure, and FIG. 6 is a cross-sectional view exemplarily illustrating a coupling structure between a horizontal connection member and the battery module provided at the uppermost end portion in the battery pack according to an exemplary embodiment of the present disclosure. FIG. 7 is a cross-sectional view exemplarily illustrating a coupling structure between the base plate and the battery module provided at the lowermost end portion in the battery pack according to an exemplary embodiment of the present disclosure.

Meanwhile, the battery pack 10 according to an exemplary embodiment of the present disclosure may include a first connection portion 300 configured to connect the two battery modules 100 provided adjacent to each other in the vertical direction. According to an exemplary embodiment of the present disclosure, the cooling plate 200 may be provided between the two battery modules 100 adjacent to each other in the vertical direction. However, the two adjacent battery modules 100 may be directly connected to each other by the first connection portion 300 without using the cooling plate 200.

As illustrated in FIG. 3, FIG. 4, and FIG. 5, the first connection portion 300 may include a first mediation member 310 provided between the two battery modules 100 provided adjacent to each other in the vertical direction. The first mediation member 310 may be provided to be in contact with the two battery modules 100 provided adjacent to each other. Furthermore, the first connection portion 300 may include an insertion member 320 provided to penetrate the first mediation member 310 and one side of each of the two battery modules 100 provided adjacent to each other in the vertical direction. The insertion member 320 may be one of various members such as studs, nails, and bolts.

Meanwhile, as described above, according to an exemplary embodiment of the present disclosure, the two adjacent battery modules 100 may be directly connected to each other by the first connection portion 300 without using the cooling plate 200. In the instant case, according to an exemplary embodiment of the present disclosure, the insertion member 320 of the first connection portion 300 may be provided to be physically spaced apart from the cooling plate 200. In the instant case, in comparison with a case in which the two battery modules adjacent to each other in the vertical direction are connected indirectly by the cooling plate, the battery pack may be stably manufactured even though the cooling plate does not include a completely flat shape because of a tolerance or the like, and it is possible to prevent physical rigidity of the battery pack from being degraded by a tolerance accumulated by the stacked structure of the battery pack. Meanwhile, with reference to FIGS. 3, 4, 5, and the like, the first mediation member 310 and the cooling plate 200 may be provided to be spaced apart from each other and overlap each other in the vertical direction. It may be understood that the first mediation member 310 and the cooling plate 200 are physically spaced apart from each other, and at least a portion of the first mediation member 310 and at least a portion of the cooling plate 200 are disposed at the same height in the vertical direction.

With continued reference to FIG. 3 and FIG. 4, the battery module 100 may further include an end cap member 120 provided to face one side of the battery stack 110 and fix the battery stack 110. For example, the battery module 100 may include an endplate configured to press the battery stack to provide surface pressure to the battery stack, and the end cap member 120 may be fixedly coupled to the endplate.

Meanwhile, the end cap member 120 may be divided into plurality of regions depending on the function and shape thereof. With reference to FIG. 3 and FIG. 4 and the like, the end cap member 120 may include an end cap body 122 configured to define a region facing the battery stack 110, and an end cap connection region 124 protruding to the outside from the end cap body 122 and provided to face the first mediation member 310 in the vertical direction. In the instant case, the insertion member 320 may be provided to penetrate the first mediation member 310 and the end cap connection region 124. Meanwhile, for example, the end cap connection region 124 may protrude from the end cap body 122 in a direction away from the battery stack 110 to which the end cap body 122 is fixed.

Furthermore, the battery module 100 may include a plurality of sub-modules 100a. As illustrated in FIG. 1, FIG. 2, FIG. 3, and FIG. 4, the battery module 100 may include the plurality of sub-modules 100a each including the plurality of battery stacks 110 and the end cap members 120. That is, the battery stack 110 and the end cap members 120, which are respectively provided at two opposite sides of the battery stack 110 based on the horizontal direction, may form one sub-module 100a, and the plurality of sub-modules 100a may form one battery module 100. In one battery module 100, the plurality of sub-modules 100a may be provided to be spaced apart from one another in the horizontal direction. Furthermore, in one battery module 100, the end cap member 120 in the sub-module 100a may be provided to face and spaced apart from the end cap member 120 in another sub-module 100a provided adjacent to the end cap member 120 in the horizontal direction. As illustrated in FIG. 3 and FIG. 4, the end cap connection regions 124 of the end cap members 120 in the two sub-modules 100a provided adjacent to each other in the horizontal direction may be provided to protrude in a direction toward each other.

Meanwhile, as described above, the battery pack 10 may include the two or more battery modules 100. Therefore, the two or more battery modules 100 may include an upper battery module, and a lower battery module disposed below the upper battery module and facing the upper battery module. In the instant case, it is noted that the upper battery module and the lower battery module are defined as relative concepts. That is, a certain battery module may be the upper battery module based on a relationship with another battery module disposed below the battery module but be the lower battery module based on a relationship with yet another battery module disposed above the battery module.

In the instant case, with reference to FIGS. 1 to 7, at least some of the plurality of sub-modules 100a in the upper battery module may be spaced apart from at least some of the sub-modules 100a in the lower battery module in the vertical direction and provided to overlap at least some of the sub-modules 100a in the lower battery module in the horizontal direction, and the insertion member 320 of the first connection portion 300 may be provided to penetrate the end cap connection region 124 of the end cap member 120, which is provided in the sub-module 100a in the upper battery module, and the end cap connection region 124 of the end cap member 120 provided in the sub-module 100a in the lower battery module.

Meanwhile, with reference to FIG. 6, the first connection portion 300 may further include a horizontal connection member 330 configured to connect the end cap members 120 provided in the two sub-modules 100a provided adjacent to each other in the horizontal direction in one battery module 100. For example, FIG. 6 illustrates a state in which the horizontal connection member 330 connects the end cap members 120 provided in the two sub-modules 100a provided adjacent to each other in the horizontal direction in the battery module 100 provided at the uppermost end portion among the two or more battery modules 100. However, in contrast, the horizontal connection member 330 may be configured to connect the end cap members 120 provided in another battery module 100 other than the battery module 100 provided at the uppermost end portion.

With continued reference to FIG. 6, the insertion member 320, which penetrates the end cap member 120 provided in one of the two sub-modules 100a provided adjacent to each other in the horizontal direction, may penetrate a first side of the horizontal connection member 330, and the insertion member 320, which penetrates the end cap member 120 provided in the other of the two sub-modules 100a provided adjacent to each other in the horizontal direction, may penetrate a second side of the horizontal connection member 330. In the instant case, the horizontal connection member 330 is configured to relatively fix the sub-modules 100a provided adjacent to each other in the horizontal direction in one battery module 100.

Meanwhile, as illustrated in FIG. 5, in case that the insertion member 320 penetrates the upper battery module and the lower battery module, a first recessed section 124a may be formed in the end cap connection region 124 of the end cap member 120 provided in the sub-module 100a in the lower battery module. The first recessed section 124a may include a recessed shape opened upward, and the insertion member 320 may be seated in the first recessed section 124a. That is, an upper side of the first recessed section 124a may be opened, and a lower side of the first recessed section 124a may be closed by a lower surface of the first recessed section. In the instant case, a lower end portion of the insertion member 320 may be provided to be spaced apart from the lower surface of the first recessed section 124a. It may be understood that a predetermined empty space is formed by the insertion member 320 and the first recessed section 124a.

With reference to FIGS. 3 and 7, the battery pack according to an exemplary embodiment of the present disclosure may further include the base plate 400 configured to define a lower surface of the battery pack. Meanwhile, the plurality of cooling plates 200 may also be stacked to correspond to the configuration in which the plurality of battery modules 100 are stacked in the vertical direction in the battery pack 10. In the instant case, in addition to the cooling plate inserted between the two battery modules 100 provided adjacent to each other in the vertical direction, the cooling plates 200 may further include a lowermost end cooling plate 200b provided between the base plate 400 and the battery module 100 provided at the lowermost end portion among the two or more battery modules 100.

Furthermore, the first connection portion 300 may further include a bottom insertion member 340 provided to penetrate the base plate 400 and one side of the battery module 100 provided at the lowermost end portion. In the instant case, like the insertion member 320, the bottom insertion member 340 may also be provided to be spaced apart from the lowermost end cooling plate 200b. That is, the base plate 400 and the battery module 100 provided at the lowermost end portion may be directly connected to each other by the bottom insertion member 340.

With continued reference to FIG. 7, a second recessed section 400a including a recessed shape opened upward may be formed in the base plate 400, and the bottom insertion member 340 may be seated in the second recessed section 400a. That is, an upper side of the second recessed section 400a may be opened, and a lower side of the second recessed section 400a may be closed by a lower surface of the second recessed section 400a. In the instant case, a lower end portion of the bottom insertion member 340 may be provided to be spaced apart from a lower surface of the second recessed section 400a. It may be understood that a predetermined empty space is formed by the bottom insertion member 340 and the second recessed section 400a.

With reference to FIGS. 3 and 6, the cooling plates 200 may further include an uppermost end cooling plate 200a provided above the battery module 100 provided at the uppermost end portion among the two or more battery modules 100.

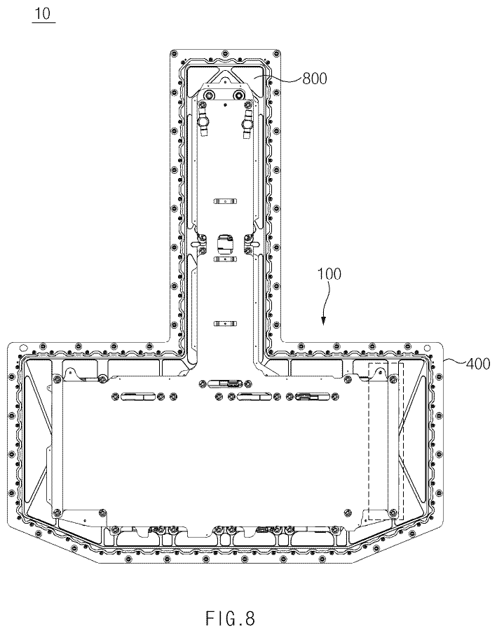

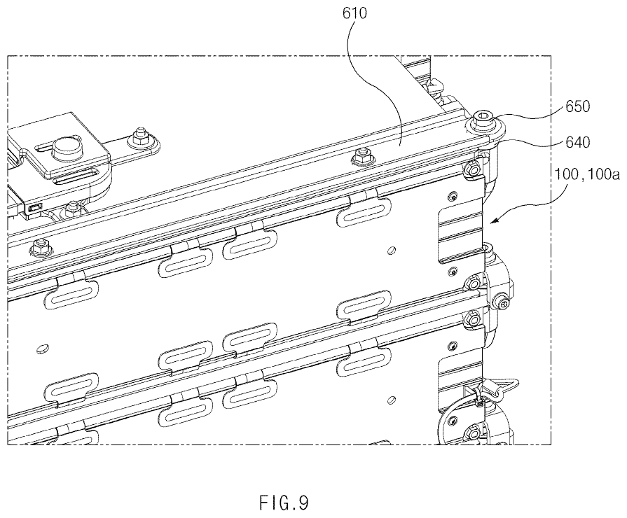

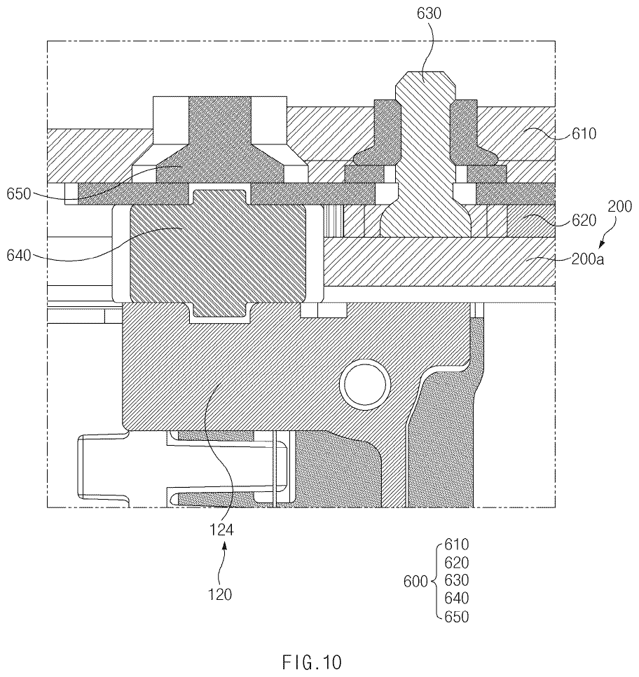

FIG. 8 is a top plan view of the battery pack according to an exemplary embodiment of the present disclosure, and FIG. 9 is an enlarged view exemplarily illustrating a state in which an upper reinforcement member is coupled to an upper portion of the battery module provided at the uppermost end portion in FIG. 8. FIG. 10 is a cross-sectional view exemplarily illustrating a coupling structure between a second connection portion and the battery module provided at the uppermost end portion in FIG. 8.

With reference to FIGS. 3, 6, and 8 to 10, the battery pack 10 according to an exemplary embodiment of the present disclosure may further include a second connection portion 600 coupled to one side of the uppermost end cooling plate 200a. The second connection portion 600 may be configured to mediate connection between the battery stacks 110 in the battery module 100 provided at the uppermost end portion. The second connection portion 600 may include an upper reinforcement member 610 provided above the uppermost end cooling plate 200a, a pad member 620 provided between the upper reinforcement member 610 and the uppermost end cooling plate 200a, and a stud member 630 provided to penetrate the upper reinforcement member 610 and the uppermost end cooling plate 200a. Meanwhile, the pad member 620 may include or be made of a material having elasticity. That is, according to an exemplary embodiment of the present disclosure, the upper reinforcement member 610 and the uppermost end cooling plate 200a may be fixed by the stud member 630 of the second connection portion 600. The stud member 630 may be provided to be spaced apart from the pad member 620.

With continued reference to FIGS. 3, 6, and 8 to 10, the second connection portion 600 may further include components configured to fix the upper reinforcement member 610 and the end cap member 120 provided in the sub-module 100a of the battery module 100 provided at the uppermost end portion. The second connection portion 600 may further include a second mediation member 640 provided between the upper reinforcement member 610 and the end cap connection region 124 of the end cap member 120 provided in the sub-module 100a of the battery module 100 provided at the uppermost end portion among the two or more battery modules, and a coupling member 650 coupled to the second mediation member 640 and provided to face the second mediation member 640 with the upper reinforcement member 610 interposed therebetween. That is, the upper reinforcement member 610 and the battery module 100 provided at the uppermost end portion may be fixed by the second mediation member 640 and the coupling member 650 of the second connection portion 600. For example, the first mediation member 310 and the second mediation member 640 may be made of the same material.

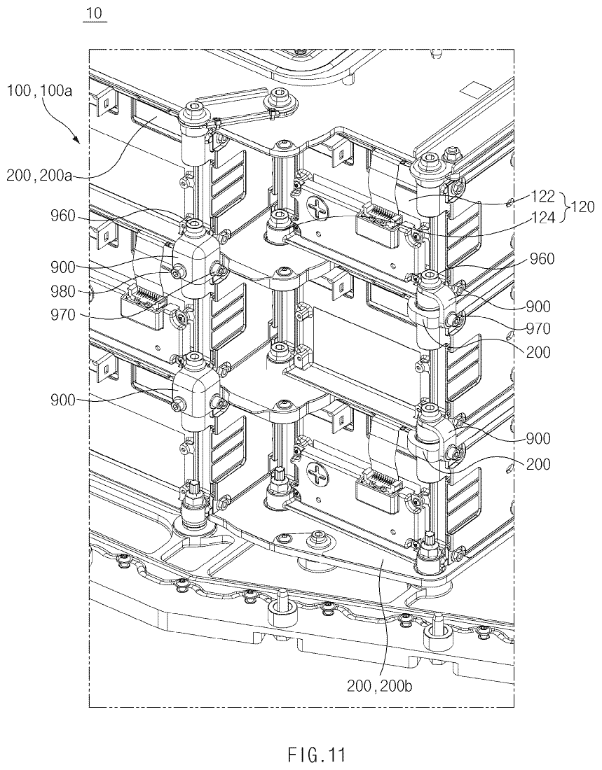

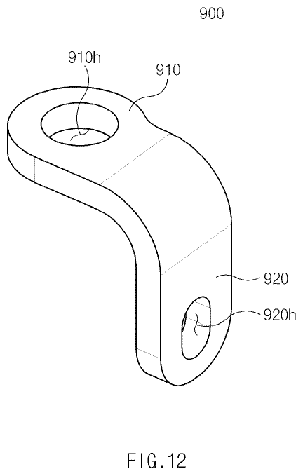

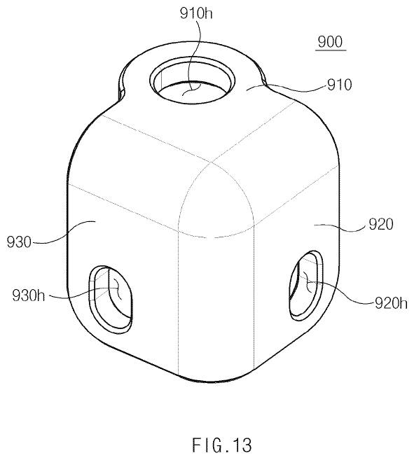

FIG. 11 is a perspective view for explaining a connection structure between the battery module and the cooling plate in the battery pack according to an exemplary embodiment of the present disclosure, and FIG. 12 is an enlarged perspective view exemplarily illustrating one of reinforcement connection members in FIG. 11. FIG. 13 is an enlarged perspective view exemplarily illustrating another of the reinforcement connection members in FIG. 11.

Meanwhile, with reference to FIG. 11, FIG. 12 and FIG. 13, the battery pack 10 according to an exemplary embodiment of the present disclosure may further include reinforcement connection members 900 configured to connect and fix the battery modules 100 and the cooling plates 200 provided adjacent to one another in the vertical direction. In the instant case, as illustrated in FIG. 11 and FIG. 12, the reinforcement connection member 900 may include a first surface region 910 including one side facing one side of the battery module 100, and a second surface region 920 including one side facing one side of the cooling plate 200. The first surface region 910 and the second surface region 920 may be directly connected to each other. However, as illustrated in FIG. 11 and FIG. 12, the first surface region 910 and the second surface region 920 may be connected to each other indirectly by a curved surface.

The first surface region 910 may be provided to face one side of the battery module 100 in the vertical direction, and the second surface region 920 may be provided to face one side of the cooling plate 200 in the horizontal direction.

Meanwhile, the reinforcement connection members 900 provided in the battery pack may be classified into two or more types of reinforcement connection members depending on the shapes thereof.

As illustrated in FIG. 12, the reinforcement connection member 900 may include only the first surface region 910 and the second surface region 920.

In contrast, as illustrated in FIGS. 11 and 13, in addition to the first surface region 910 and the second surface region 920, the reinforcement connection member 900 may further include a third surface region 930 including one side facing the other side of the cooling plate 200. The third surface region 930 may be provided to face the other side of the cooling plate 200 in the horizontal direction. Meanwhile, the third surface region 930 may be orthogonal to the second surface region 920, the third surface region 930 may be orthogonal to the first surface region 910, and the first surface region 910 may be orthogonal to the second surface region 920. Meanwhile, the first surface region 910 may be provided to face one region of the end cap member 120 in the battery module 100 in the vertical direction. That is, the first surface region 910 may be coupled to the end cap member 120.

Meanwhile, the battery pack according to an exemplary embodiment of the present disclosure may further include a separate coupling member configured to fix the reinforcement connection member 900 to one side of the battery module 100 and the cooling plate 200. The battery pack 10 may further include a first coupling member 960 provided to penetrate the first surface region 910 of the reinforcement connection member and one side of the battery module 100, a second coupling member 970 provided to penetrate the second surface region 920 of the reinforcement connection member and one side of the cooling plate 200, and a third coupling member 980 provided to penetrate the third surface region 930 of the reinforcement connection member and the other side of the cooling plate 200.

Furthermore, a first hole 910h may be formed in a region of the first surface region 910 penetrated by the first coupling member 960, a second hole 920h may be formed in a region of the second surface region 920 penetrated by the second coupling member 970, and a third hole 930h may be formed in a region of the third surface region 930 penetrated by the third coupling member 980. In the instant case, the first hole 910h may include a shape of a circle, whereas the second hole 920h and the third hole 930h may each include a shape in which a width in the vertical direction and a width in the horizontal direction are different from each other.

A width of the second hole 920h in the vertical direction may be greater than a width of the second hole 920h in the horizontal direction, and a width of the third hole 930h in the vertical direction may also be greater than the width of the third hole 930h in the horizontal direction This may be to couple the second coupling member 970 and the third coupling member 980 to the cooling plate 200 while coping with a change in position of the cooling plate 200 in the vertical direction even though the position of the cooling plate 200 in the vertical direction is somewhat changed by tolerances accumulated during the process of manufacturing the battery pack.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing predetermined embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a predetermined condition is satisfied, to perform the related operation or interpret the related definition according to the predetermined condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery pack comprising:
two or more battery modules stacked in a first direction and each including a plurality of battery stacks disposed in a second direction;
cooling plates provided between the two or more battery modules; and
a first connection portion connecting the two battery modules disposed adjacent to each other in the first direction,
wherein the first connection portion includes:
a first mediation member provided between the two battery modules disposed adjacent to each other in the first direction; and
an insertion member penetrating the first mediation member and one side of each of the two battery modules disposed adjacent to each other in the first direction, and
wherein the insertion member is spaced apart from the cooling plates.

2. The battery pack of claim 1, wherein the first mediation member and the cooling plate are spaced apart from each other.

3. The battery pack of claim 1, wherein the first mediation member and the cooling plate overlap each other in the first direction.

4. The battery pack of claim 1,
wherein each battery module further includes an end cap member facing one side of the battery stack and fixing the battery stack,
wherein the end cap member includes:
an end cap body defining a region facing the battery stack; and
an end cap connection region protruding to the outside from the end cap body and facing the first mediation member in the first direction, and
wherein the insertion member penetrates the first mediation member and the end cap connection region.

5. The battery pack of claim 4,
wherein each battery module includes a plurality of sub-modules each including the plurality of battery stacks and the end cap member,
wherein the plurality of sub-modules are spaced apart from one another in the second direction, and
wherein, among the plurality of sub-modules, an end cap member in a sub-module faces an end cap member in another sub-module provided adjacent to the end cap member in the sub-module in the second direction.

6. The battery pack of claim 5, wherein end cap connection regions of end cap members in two sub-modules disposed adjacent to each other in the second direction among the plurality of sub-modules protrude in a direction toward each other.

7. The battery pack of claim 6,
wherein the two or more battery modules include:
an upper battery module; and
a lower battery module disposed below the upper battery module and facing the upper battery module, and
wherein at least some of the plurality of sub-modules in the upper battery module overlap at least some of the plurality of sub-modules in the lower battery module in the second direction.

8. The battery pack of claim 7,
wherein the first connection portion further includes a horizontal connection member connecting the end cap members in the two sub-modules disposed adjacent to each other in the second direction,
wherein an insertion member, which penetrates an end cap member provided in one of the two sub-modules disposed adjacent to each other in the second direction, penetrates a first side of the horizontal connection member, and
wherein an insertion member, which penetrates an end cap member provided in another of the two sub-modules disposed adjacent to each other in the second direction, penetrates a second side of the horizontal connection member.

9. The battery pack of claim 8, wherein the horizontal connection member connects the two sub-modules disposed adjacent to each other in the second direction in a battery module provided at an uppermost end portion among the two or more battery modules.

10. The battery pack of claim 7, wherein the insertion member penetrates the end cap connection region of the end cap member, which is provided in a sub-module in the upper battery module, and the end cap connection region of the end cap member provided in a sub-module in the lower battery module.

11. The battery pack of claim 10,
wherein a first recessed section including a recessed shape opened upward is formed in the end cap connection region of the end cap member provided in the sub-module in the lower battery module so that the insertion member is seated in the first recessed section, and
wherein a lower end portion of the insertion member is spaced apart from a lower surface of the first recessed section.

12. The battery pack of claim 1, further including:
a base plate defining a lower surface of the battery pack,
wherein the cooling plates further include a lowermost end cooling plate additionally provided between the base plate and a battery module provided at a lowermost end portion among the two or more battery modules, and
wherein the first connection portion further includes a bottom insertion member penetrating the base plate and one side of the battery module provided at the lowermost end portion.

13. The battery pack of claim 12, wherein the bottom insertion member is spaced apart from the lowermost end cooling plate.

14. The battery pack of claim 12,
wherein a second recessed section including a recessed shape opened upward is formed in the base plate so that the bottom insertion member is seated in the second recessed section, and
wherein a lower end portion of the bottom insertion member is spaced apart from a lower surface of the second recessed section.

15. The battery pack of claim 1,
wherein the cooling plates include an uppermost end cooling plate provided above a battery module provided at an uppermost end portion among the two or more battery modules,
wherein the battery pack further includes a second connection portion coupled to one side of the uppermost end cooling plate, and
wherein the second connection portion includes:
an upper reinforcement member provided above the uppermost end cooling plate;
a pad member provided between the upper reinforcement member and the uppermost end cooling plate; and
a stud member penetrating the upper reinforcement member and the uppermost end cooling plate.

16. The battery pack of claim 15, wherein the stud member is spaced apart from the pad member.

17. The battery pack of claim 15, wherein the second connection portion further includes:
a second mediation member disposed between the upper reinforcement member and an end cap connection region of an end cap member provided in a sub-module of the battery module provided at the uppermost end portion among the two or more battery modules; and
a coupling member coupled to the second mediation member and facing the second mediation member with the upper reinforcement member interposed therebetween.

18. The battery pack of claim 1, further including:
a reinforcement connection member connecting a battery module and a cooling plate disposed adjacent to each other in the first direction among the two or more battery modules and the coupling plates,
wherein the reinforcement connection member includes:
a first surface region including one side facing one side of the battery module; and
a second surface region including one side facing one side of the cooling plate.

19. The battery pack of claim 18, wherein the first surface region faces the one side of the battery module in the first direction, and the second surface region faces the one side of the cooling plate in the second direction.

20. The battery pack of claim 19, further including:
a first coupling member penetrating the first surface region and the one side of the battery module; and
a second coupling member penetrating the second surface region and the one side of the cooling plate.

21. The battery pack of claim 20, wherein a first hole is formed in a region of the first surface region penetrated by the first coupling member, the first hole includes a shape of a circle, a second hole is formed in a region of the second surface region penetrated by the second coupling member, and the second hole includes a shape in which a width in the first direction and a width in the second direction are different from each other.

22. The battery pack of claim 21, wherein the width of the second hole in the first direction is greater than the width of the second hole in the second direction.

23. The battery pack of claim 20,
wherein the reinforcement connection member further includes a third surface region including one side facing another side of the cooling plate, and
wherein the third surface region faces the another side of the cooling plate in the second direction.

24. The battery pack of claim 23, wherein the third surface region is orthogonal to the second surface region.

25. The battery pack of claim 23, further including:
a third coupling member penetrating the third surface region and the another side of the cooling plate,
wherein a third hole is formed in a region of the third surface region penetrated by the third coupling member, and the third hole includes a shape in which a width in the first direction and a width in the second direction are different from each other.

26. The battery pack of claim 25, wherein the width of the third hole in the first direction is greater than the width of the third hole in the second direction.
